(19) United States
(12) Patent Application Publication
(10) Pub. No.: US 2009/0100737 A1
(43) Pub. Date: Apr. 23, 2009

(54) LIVE AND DEAD BAIT SPINNER APPARATUS

(76) Inventor: DARREN HUNTER, FORTUNA, CA (US)

Correspondence Address: STAINBROOK & STAINBROOK, LLP, 412 AVIATION BOULEVARD, SUITE H, SANTA ROSA, CA, 95403, US

(21) Appl. No.: 12/256,417

(22) Filed: Oct. 22, 2008

Related U.S. Application Data
(60) Provisional application No. 60/981,573, filed on Oct. 22, 2007.

(51) Int. Cl. A01K 85/00

(52) U.S. Cl. 43/4.5; 43/44.4

(57) ABSTRACT

A fishing lure and spinner apparatus that includes first and second fin elements, a flexible medial band disposed between the first and second fin elements, first and second corner portions, one each disposed between and connecting the first and second adjustable fin elements to the medial band, first and second adjustment creases, one each interposed between the flexible medial band and the first and second adjustable fin elements, and a fastener assembly to secure said apparatus to a live or dead bait fish.

### CROSS REFERENCES TO RELATED APPLICATIONS

The present application claims the benefit of the filing date of U.S. Provisional Patent Application Ser. No. 60/981,573, filed Oct. 22, 2007 (Oct. 22, 2007).

### SEQUENCE LISTING

Not applicable.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates most generally to fishing tackle, and more particularly to fishing lures, and still more particularly to a spinning apparatus for use with live or dead bait.

2. Discussion of Related Art Including Information Disclosed Under 37 CFR §§1.97, 1.98

The art and science of fishing is ancient, and devices conceived by anglers to attract fish are simply too numerous to count. A common principle informing lure design is to provide a device that closely mimics the most attractive prey for the sought-after predatory species of fish. This may comprise a fish fly, for instance, or just as commonly, a lure. In accordance with the general design principle, lures are frequently made not only to mimic the appearance, but also the movements, of bait fish. A departure from this principle is the spinning lure, which generally does not imitate nature, but nonetheless has a mysterious attractive property that works to attract fish. In the field of spinning lures, there are countless practical embodiments.

While spinners made of artificial materials have proven success, the use of live bait for fishing has several advantages over artificial devices, not the least of which are the visual and olfactory cues given to the sought-after game fish. However, in order to securely attach live bait to a fishing line, most bait holders entail the use of means (such as a hook) to hold the bait. This frequently injures or kills the bait so that it does not move or behave optimally, and perhaps not at all. Dead bait may be therefore be preferred, and it has the advantage of being much easier to store in a frozen condition for use at any later time. However, when using dead bait, it is still advantageous to have the bait move in an alluring fashion in the water. Accordingly, it is desirable to have means for securing live or dead bait to a fishing line which either does not injure the bait or replaces its natural movements with equally alluring movements when in use, or which provides movement to otherwise motionless dead bait.

Several designs have been proposed and tried for natural bait holding lures. Notable among them are the following:

U.S. Pat. No. 5,611,168 to Schultz, et al, teaches a deep sea fishing lure for securing bait. The lure includes a housing with upper and lower cylindrical half jaws that are pivotally connected at their front ends and biased together by a spring. Teeth inside the jaws grip bait captured between the jaws. The lure includes a wall ahead of the front rows of teeth which prevents water from passing through the interior of the bait housing and washing out bait.

U.S. Pat. No. 7,257,923 to Urbano, Jr, describes a fishing lure includes a bait fish holder for receiving the head of a bait fish. The fish holder is secured by a pin extending through the head of the bait, thus killing the fish. Outwardly projecting wing members and fins on the bait fish holder promote the rotational movement and enhance the dive capabilities of the lure.

U.S. Pat. No. 6,708,442 to Kress, et al, shows a reflective hood for use with a natural bait fish or artificial lure bait fish. The bait fish head is captured in the hood, which is shaped to resemble a bait fish head and further includes two eyes. The fishing line with a hook attached passes through a hole in the front or nose portion of the hood and passes into the body of the bait fish, with the hook extending from the bait fish in the mid-body region.

U.S. Pat. No. 6,658,785 to Faulkner, et al, teaches a lure for mounting bait fish includes a unitary weighted body having a socket for receiving the nose of the bait fish and a lower tail section having inwardly projecting hooks for penetrating the sides of the bait fish to effect a secure, properly oriented mounting. The hydrodynamics of the lure keep the fish in a generally upright orientation.

U.S. Pat. No. 5,893,232 to Horton, et al, the present invention is a natural bait holding fishing lure for use with dead bait fish. The minnow head shaped lure includes a rod or tail to impale the bait as it is inserted head first into the cavity of the lure. Also connected to the lure is a pivoting L shaped barbed locking pin device, and a metal foil which deflects water to simulate the swimming motion of a live minnow when trolled through the water with the bait attached, and thus promotes attraction of the target fish.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein. Specifically, none of the lures in the above-identified patents are adapted for use with live bait. Furthermore, many of the “hood” type designs, i.e., those that slip over the bait fish head, conceal an important part of the fish and render the exposed bait less natural in its appearance. Finally, fine tuning and adjustment of the spinning characteristics are not possible or impractical with the lures described above.

### BRIEF SUMMARY OF THE INVENTION

The present invention therefore provides a lure and spinner apparatus that may be installed on either live or dead fish bait (such as anchovies or fish fry) to impart a desired spinning motion to the bait when trolled through or dragged in water. The spinning characteristics of the lure may be easily adjusted to best mimic, accentuate, or complement the type of bait employed. The lure does not include the use of barbs, hooks, pins, or other structure to pierce or penetrate the bait fish body, nor does it pin down the gills of the fish, thereby making it possible to keep the bait alive during use. Furthermore, the apparatus does not obscure the head, eyes, and mouth of the bait fish, thus preserving a high degree of the natural appearance of the bait fish.

It is therefore an object of the present invention to provide a new and improved fishing lure and spinner apparatus that may be used with either live or dead bate.

It is another object of the present invention to provide a new and improved fishing spinner apparatus that has adjustment means so that the motion of the bait as it is dragged in water may be varied to create the most alluring shape to sought-after game fish.

A further object or feature of the present invention is a new and improved fishing spinner apparatus that is lightweight and easy to manipulate with cold, wet hands.

An even further object of the present invention is to provide a novel fishing spinner apparatus that is inexpensive and thus expendable.

Still another object of the present invention is to provide a novel fishing spinner apparatus that may be adjusted to vary the rapidity with which the bait spins as it moves through the water.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

Accordingly, before explaining the preferred embodiment of the disclosure in detail, it is to be understood that the disclosure is not limited in its application to the details of the construction and the arrangements set forth in the following description or illustrated in the drawings. The inventive apparatus described herein is capable of other embodiments and of being practiced and carried out in various ways.

Also, it is to be understood that the terminology and phraseology employed herein are for descriptive purposes only, and not limitation. Where specific dimensional and material specifications have been included or omitted from the specification or the claims, or both, it is to be understood that the same are not to be incorporated into the appended claims.

As such, those skilled in the art will appreciate that the conception, upon which this disclosure is based may readily be used as a basis for designing other structures, methods, and systems for carrying out the several purposes of the present invention. It is important, therefore, that the claims are regarded as including such equivalent constructions as far as they do not depart from the spirit and scope of the present invention. Rather, the fundamental aspects of the invention, along with the various features and structures that characterize the invention, are pointed out with particularity in the claims annexed to and forming a part of this disclosure. For a better understanding of the present invention, its advantages and the specific objects attained by its uses, reference should be made to the accompanying drawings and descriptive matter in which there are illustrated the preferred embodiment.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is an upper left perspective view showing the inventive apparatus in relation to a piece of live/dead fish bait (wherein the fish is shown schematically and generically, without a number of commonly found anatomical features, such as a dorsal fin, anal fin, pectoral and pelvic fins, and the like);

FIG. 2 is an upper left perspective view showing the apparatus of FIG. 1 installed on a small fish and having its fin elements differentially adjusted;

FIG. 3 is a front view in elevation showing the fin elements of the spinner apparatus adjusted outwardly to induce rotation of the bait fish as it is trolled through the water; and

FIG. 4 is a bottom (ventral) view showing the fin elements adjusted inwardly, toward the body of the bait fish.

### DETAILED DESCRIPTION OF THE INVENTION

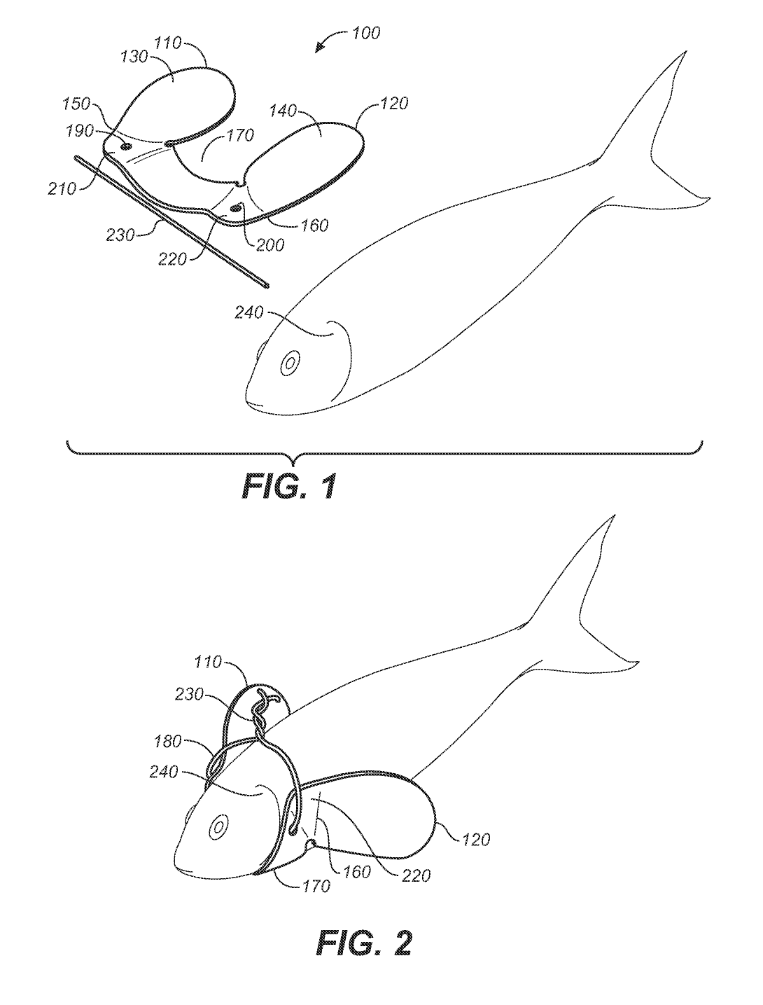

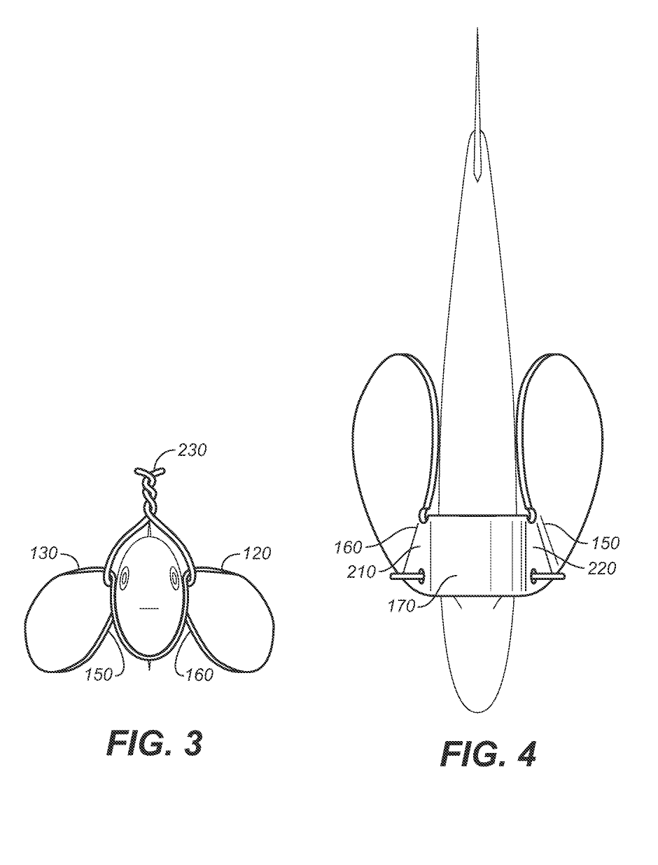

Referring to FIGS. 1 through 4, wherein like reference numerals refer to like components in the various views, there is illustrated a new and improved live and dead bait spinner apparatus, generally denominated 100 herein. FIGS. 1-4 collectively illustrate a preferred embodiment of the fish spinning apparatus of the present invention, and show that the inventive device includes (a) first and second wing or fin elements 110, 120, for diverting fluid flowing over the fin, in the manner of a wing or fin, each fin having (b) a lobe portion 130, 140, respectively, and (c) an adjustment crease or fold 150, 160, which is connected to (d) a flexible medial band 170 or ventral cradle; (e) fastening means 180, preferably comprising first and second through holes 190, 200 one each disposed in a corner portion 210, 220 comprising the region between the fin elements and the flexible medial band and proximate the adjustment crease; and (f) a flexible twist tie 230, wire, line, or another fastener element. The lobe portions have a generally oval aspect with a longitudinal dimension that is oriented substantially normal to the longitudinal dimension of the medial band. The interior intersection of the fin elements and medial band may include a scalloped out arcuate recess to reduce metal fatigue and prevent breaking when adjustments are made. The overall configuration gives the apparatus a slight rabbit ear type appearance.

FIGS. 2-4 show how the device 100 is installed on either live or dead bait 220. This entails simply placing the flexible medial band on the ventral side of the fish immediately underneath and behind the gills 230. The band is wrapped around the ventral portion of the fish and may be shaped to closely conform to the ventral and side aspects of the fish. The band portion extends upwardly alongside the rear border of the operculum (gill cover) 240, where the fin elements extend outwardly from the fish. The band is placed fore of the point of greatest girth and is thus prevented from sliding backwards during use. While pectoral and pelvic fins may be slightly or fully restrained, if the fish is alive and to be kept alive, the gill cover is not pinned down or otherwise obstructed or restrained and will continue to allow gill function. Further, placement of the band is such that the gills operate to prevent slippage of the apparatus forward and over the head of the fish as the fish is pulled through the water.

Next, the fin elements may be adjusted either inwardly or outwardly, or differentially relative to one another. This is facilitated by the adjustment creases 150, 160, which comprise slightly indented depressions or channels running transversely from one edge of the lobe to the other. The material is simply thinner relative to neighboring material and therefore bends more easily at the adjustment creases. The flexible material from which the spinner is made also allows for some twisting and bending of the fin elements at the ends of the lobes 130, 140, and/or within the lobes, and these adjustments, alone and in combination, are used to modify the size and shape of the spinning pattern or circle in which the bait spins as well as the rapidity with which it spins when moving through water. The flexible twist tie 230 secures the device over the dorsal side between the head and any dorsal fin and spines that may be present. This adjustment feature is essential in providing the optimal movement characteristics that best complement or mimic the kind of bait fish used.

Once the lure is secured on the bait fish, the fish is attached to the fishing line, preferably by securing a hook through the mouth. It is assumed that the line comprises a conventional leader line with a conventional swivel (snap, ball bearing, snap, or crane-snap), which devices are so well known in the art that they need not be shown herein. When thus secured, and when trolled through relatively still water or placed in running stream, the lure and spinning apparatus of the present invention allows the bait fish to rotate, spin in funicular patterns, wiggle, or otherwise move in a manner attractive to nearby predatory fish.

As will be readily appreciated, affixing the spinning apparatus of the present invention does not involve penetrating the bait fish body with sharp barbs, hooks, rods, or other elements that generally kill the fish. Rather, the flexible medial portion covers a minimal amount of the fish body and does not interfere with gill function. Because the device so minimally covers the fish, and does not at all cover the fish head, the spinner preserves a high degree of naturalness in the appearance of the bait as it travels through the water.

The inventive spinner may be fabricated from any of a number of lightweight materials, including plastic, though thin and bendable metals and metal allows are preferred.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

The invention claimed is:

1. A fishing lure and spinner apparatus, comprising:
first and second adjustable fin elements;
a flexible medial band disposed between said first and second fin elements;
first and second corner portions, one each disposed between and connecting said first and second adjustable fin elements to said medial band;
first and second adjustment creases, one each interposed between said flexible medial band and said first and second adjustable fin elements; and
a fastener assembly to secure said apparatus to a live or dead bait fish.

2. The apparatus of claim 1, wherein said fastener assembly comprises first and second through holes, one each disposed in said first and second corner portions, and a line connected to each of said through holes.

3. The apparatus of claim 2, wherein said line is a flexible twist tie.

4. The apparatus of claim 1, wherein each fin element includes a lobe portion.

5. The apparatus of claim 4, wherein said lobe portion is generally oval in shape.

6. The apparatus of claim 4, wherein said fin elements are each disposed generally normal to said medial band.

7. The apparatus of claim 1, wherein said fin elements are each disposed generally normal to said medial band.

8. The apparatus of claim 1, wherein said apparatus is fabricated from a flexible metal.

9. The apparatus of claim 8, wherein said flexible metal is a metal alloy.

10. The apparatus of claim 1, wherein said corners include an interior intersection where said first and second fin elements and said medial band join, and wherein said interior intersection includes a recess.

11. The apparatus of claim 10, wherein said recess is arcuate.

12. A method of using a live or dead bait fish as a lure element, comprising the steps of:
providing a lure and spinner apparatus having first and second adjustable fin elements, each including a lobe portion, a flexible medial band disposed between the first and second fin elements, first and second corner portions, one each disposed between and connecting the first and second adjustable fin elements to the medial band, first and second adjustment creases, one each interposed between the flexible medial band and the first and second adjustable fin elements, and a fastener assembly to secure said apparatus to a live or dead bait fish;
placing the flexible medial band on the ventral side of a bait fish immediately underneath and behind the gills of the fish;
wrapping the flexible medial band around the ventral portion of the fish and shaping it to closely conform to the ventral and side aspects of the fish;
adjusting the fin elements at the adjustment creases either inwardly, outwardly, or differentially relative to one another, and selectively twisting the fin elements, the adjustments made to modify the size and shape of the spinning pattern or circle in which the bait spins as well as the rapidity with which it spins when moving through water; and
securing the lure with the fastener assembly.
